(19) United States
(12) Patent Application Publication
(10) Pub. No.: US 2008/0026246 A1
(43) Pub. Date: Jan. 31, 2008

(54) Vibration damping material of polyamides and mercaptobenzoimidazoles

(76) Inventors: Yuji Saga, (US); Makiko Ueda, (US); Yasuyuki Ohira, (US); Tatsuya Aoki, (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 11/880,727

(22) Filed: Jul. 24, 2007

Related U.S. Application Data
(60) Provisional application No. 60/833,163, filed on Jul. 25, 2006.

(51) Int. Cl. B32B 15/088; C08G 69/00; C08K 5/3417

(52) U.S. Cl. 428/626; 524/93

(57) ABSTRACT

The polyamide resin composition of the present invention is useful as a sound dampening material and includes (1) 30-97 wt % polyamide selected from (a) crystalline polyamide, (b) amorphous polyamide, or a mixture of (a) and (b), and (2) 1-30 wt % of a mercaptobenzoimidazole The polyamide resin composition of the present invention can further include a plasticizer or an inorganic filler.

### CROSS REFERENCE TO RELATED APPLICATIONS

This application claims the benefit of U.S. Provisional Application No. 60/833,163, filed Jul. 25, 2006.

### FIELD OF THE INVENTION

The present invention relates to a viscoelastic resin composition for a vibration damping material and a vibration damping material using the same. More specifically, the present invention relates to a viscoelastic resin composition capable of sufficiently absorbing a vibration energy, and an attachable vibration damping material which shows a vibration damping property by being attached to a vibrating portion, or a sandwich-type vibration damping material.

### BACKGROUND OF THE INVENTION

Noises and vibration problems have become an object of public concern as an environmental pollution with development of means of transportation and increase in residential areas which are located near factories and the like. Further, in workshops, there is a requirement to limit noises and vibration to improve the working atmosphere. To cope with these requirement, metallic materials and structures that are a source of noises and vibration can be bonded to polymer in order to absorb vibrational energy.

Composite laminate structures have been proposed wherein a middle layer having viscoelasticity is sandwiched by metal layers. This type of a composite vibration damping material has been studied and employed as oil pans of automobiles, engine covers, chutes of hoppers, stopper of conveying apparatus, domestic electric equipments, vibration reducing members of other metal processing machines, structural members of precision machines in which prevention of vibration is desirable and the like.

In general the vibration damping property of such a composite vibration damping material depends upon the properties of a viscoelastic layer which constitutes the middle layer thereof. When the vibration damping property is expressed as a loss factor (which is a measure of conversion of an external vibrational energy into a heat energy by internal friction, and is corresponding to a value relating to mechanical hysteresis loss due to vibration), the property shows a peak at a certain temperature. It has been known that it is most effective to use a vibration damping material at about this temperature showing the peak property.

A composite vibration damping material should therefore have a high value of the above loss factor as well as a high adhesive strength between a viscoelastic middle layer and a metal layer. The composite vibration damping materials made of known viscoelastic compositions have problems in meeting all of the requirements of an ideal material and are unsatisfactory in one way or another. In addition to the above requisite properties, it is necessary that a composite vibration damping material should stand processing such as press, bending and the like. A composite vibration damping material made of the conventional viscoelastic compositions is liable to produce wrinkle, crack and the like, and is also unsatisfactory.

Hitherto, the following examples of a resin layer of the sandwich-type vibration damping material have been known: a simple polyester resin (Japanese Laid-Open Patent Publication No. 50-143880); a resin composition obtained by adding a plasticizer to a polyester (Japanese Laid-Open Patent Publication No. 51-93770); a resin composition obtained by mixing an organic peroxide with a polyester (Japanese Laid-Open Patent Publication Nos. 51-41080 and 51-83640); a resin composition which is a combination of a plurality of polyesters (Japanese Laid-Open Patent Publication Nos. 62-295949 and 63-202446); a simple polyurethane foam (Japanese Laid-Open Patent Publication No. 51-91981), a simple polyamide resin (Japanese Laid-Open Patent Publication No. 56-159160); a simple ethylene-polyvinyl acetate copolymer (Japanese Laid-Open Patent Publication No. 57-34949); a resin composition obtained by adding a plasticizer and a tackifier to a polyvinyl butyral or to a combination of a polyvinyl butyral and a polyvinyl acetate (Japanese Patent Publication No. 55-27975); a copolymer of a isocyanate prepolymer and a vinyl monomer (Japanese Patent Publication No. 52-26554); copolymers disclosed in Japanese Laid-Open Patent Publication No. 60-258262, Japanese Patent Publication Nos. 39-12451 and 45-34703, and U.S. Pat. No. 4,447,493; and the like.

Polyamide resin material is lighter than metal and has excellent dampening property, rigidity, heat resistance, oil resistance, etc. It is used as various types of molding material, for example, for automobile parts in order reduce weight and noise.

For example, Japanese Kokai Patent Application No. Hei 2[1990]-120360 discloses a polyamide composition, which contains nylon 6 resin, nylon 66 resin, and an aromatic amorphous nylon in prescribed amounts as essential components, and can be used to manufacture molding products used for mechanical parts with improved dampening characteristics and mechanical characteristics.

Also, Japanese Kokai Patent Application No. Hei 3[1991]-143956 discloses a dampening resin molding product, which is made of a nylon mixture consisting a crystalline nylon resin and an amorphous nylon resin and is mechanically installed on an engine or other peripheral machines.

Japanese Kokai Patent Application No. Hei 4[1992]-89863 (patent reference 3) discloses a sound-blocking resin composition composed of a polyamide resin, such as nylon 6 or nylon 66, a plasticizer, and a reinforcing fiber.

Japanese Kokai Patent Application No. Hei 11[1999]-49950 (patent reference 4) discloses a resin material substitutable for the fixture of engine parts, which contains (A) aliphatic polyamide, (B) a half-aromatic polyamide having repeated units comprised of a part derived from aromatic carboxylic acid and a part derived from aliphatic diamine. The aforementioned resin material has good rigidity at high temperatures and is characterized by the fact that that the vibration characteristic will not deteriorate significantly due to temperature variation.

Another example of the vibration damping material includes an attachable vibration damping material in which a viscoelastic resin layer is formed on the surface of a base layer having high rigidity. The attachable vibration damping material exhibits a vibration damping property by being directly attached to a vibrating portion or a vibration transmitting portion. This material is used for the purpose of reducing noises end vibration of office apparatuses, domestic electric equipment, terminal apparatuses of computers, etc. This type of material is light-weight and easily used.

In general, the sandwich-type and attachable vibration damping materials are required to have a high loss factor in a wide range of temperatures. However, a conventional resin composition used for a viscoelastic resin layer does not fully satisfy this requirement. Moreover, in the sandwich-type and attachable vibration damping materials, high adhesion between the resin layer and the base layer or the vibration portion, and satisfactory durability under various circumstances are required. The conventional resin composition does not satisfy these requirements. The attachable vibration damping material is directly attached to a vibrating portion by adhering the resin layer thereof to the vibrating portion. Thus, in the case where a viscoelastic resin composition, which has been conventionally used for the attachable vibration damping material, is used for the resin layer, there are a number of problems involving heat-resistance and durability. At a high temperature, the resin composition is likely to be decomposed. As a result, serious problems are caused when the resin composition is used for an external memory device of a computer.

Vibration damping resins displaying viscoelastic behavior for use in forming metal laminates are known. For example, U.S. Pat. No. 4,859,523, the teachings of which are incorporated herein by reference, describes polyurethanes useful for forming metal-resin-metal composites. The viscoelastic resin layer, that adheres two metal layers, damps vibration by converting external vibrational energy to heat energy. Vibration damping is useful in reduction of noise and prevention of metal fatigue. Vibration-damped metal has a wide variety of applications where vibrational noise is of concern, particularly in the automotive industry. The use of vibration damping composites is known for oil pans, engine covers, rocker panels, air filters covers, and other automotive parts.

It can be appreciated that a viscoelastic resin must have chemical and physical stability over a wide temperature range. It must also be able to both adhere the layers of metal together and effectively damp vibration over a wide temperature range. Throughout the entire processing temperature range of the laminate-forming process, component-forming process, and baking process, the resin must not ooze from between the metal layers. The resin should provide sufficient peel strength upon formation of the composite so as to survive passage through the coil coating/laminating process or any other conditions selected to form the composite. To withstand the drawing and/or stamping steps which occurs during component formation, high lap shear strength is required.

One of the specific goals for a resin in accordance with this invention is to obtain, over a broad operating temperature range, a composite loss factor or tan(δ) of at least about 0.05 and preferably of at least about 0.1. Loss factor is a measure of conversion of external vibrational energy into heat energy by internal friction in the resin layer. The higher the loss factor, the greater the amount of vibrational energy that is converted to heat.

In other literature that describes examples of resins for vibration absorbtion, U.S. Pat. No. 4,859,523 describes a viscoelastic resin which comprises a reaction product of a polyester diol having a molecular weight of 400 to 6,000, wherein at least 60 mol % of the polyester diol is a dicarboxylic acid component which is an aromatic dicarboxylic acid and at least 30 mol % of the polyester diol is a glycol component which is neopentyl glycol or its derivative, an aliphatic polyester diol having a molecular weight of 600 to 6,000, a diisocyanate compound; and a chain extender

Metal-plastic-metal laminates have been described in various U.S. and foreign patents. Exemplary patents include U.S. Pat. No. 3,582,427, U.S. Pat. No. 4,229,504, U.S. Pat. No. 4,204,022, U.S. Pat. No. 4,313,996, U.S. Pat. No. 4,369,222 and EPA 19,835. These laminates are useful as light weight replacements for sheet steel in cars and trucks. Relatively thin laminates are useful in flexible packaging end use applications while relatively thick laminates are useful as construction laminates.

Methods of preparing such laminates are also known. One method includes bringing at least one layer of plastic and at least one layer of metal into intimate contact and subjecting them to suitable heat and pressure, using, for example, a platen press. A more efficient and continuous method involves the well known extrusion processes—extrusion coating or extrusion lamination. Often an intermediate layer of adhesive or primer, in the form of a film or coating, is used in conjunction with these methods in insure adequate adhesion between the metal substrate and the plastic.

In the past, one primary incentive for considering the replacement of sheet steel with metal-polymer laminates was the weight saving that could be obtained with equivalent stiffness. Placing thin steel skins on the outside of the laminate optimal use of high yield, high modulus steel and allows the structurally ineffective (in bending) middle portion of the composite to be light weight plastic, resulting in the primary advantage of steel-plastic laminates—weight reduction versus an equivalent stiffness sheet steel, but at substantially less cost penalty compared to other weight-reducing materials such as aluminum sheet. In other cases it has been desired to obtain sound or vibration damping from the laminate. In the past, in order to obtain such vibration damping, manufacturers would provide a laminate having relatively thick skins (400-500 μm) and a relatively thin, low modulus viscoelastic polymer core (200-300 μm). However, in order to obtain equivalent stiffness to the steel it replaced, it was necessary to increase the overall thickness of the steel in the sound damping laminate. This resulted in a much heavier laminate than the equivalent stiffness steel it replaced. What is needed are laminates that provide both light weight and sound damping.

In other examples of vibration absorbing laminates, U.S. Pat. No. 4,599,261 describes a metal-polymer-metal structural laminate comprising a core of polymeric resinous material having adhered to each side thereof a metal skin layer.

U.S. Pat. No. 5,356,715 describes a viscoelastic, vibration-damping resin consisting essentially of the reaction product between bisphenol-derived epoxy resins having terminal epoxy functionalities and providing a composite loss factor of at least about 0.05 over a temperature range of at least about 100.degree. F. (55.5.degree. C.). The '715 patent also describes a vibration-damping composite comprising a pair of metal sheets adhered together by a viscoelastic vibration-damping resin consisting essentially of the abovementioned vibration-dampling resin.

U.S. Pat. No. 5,411,810 describes a viscoelastic resin composition for a vibration damping material. The resin comprises a low Tg polyester resin and a high Tg resin which is at least one selected from the group consisting of amorphous polyester resins, phenoxy resins, and epoxy resins.

U.S. Pat. No. 6,726,957 describes a cured, thermal insulating, corrosion resisting and noise reducing coating composition comprising an epoxy resin, a mixed methyl-phenyl functional silicone polymer, a catalyst ranging from about 1-7% of the total weight of the composition, a silane ranging from about 1-3% of the total weight of the composition, an anti-corrosive pigment ranging from about 5-15% of the total weight of the composition, an inert film reinforcing pigment ranging from about 6-10% of the total weight of the composition, a plurality of calcium silicate fibers ranging from about 4-8% of the total weight of the composition, a mixture of synthetic silicone rubber, silica and fillers ranging from about 10-20% of the total weight of the composition, and an organic solvent ranging from about 5-50% of the total weight of the composition.

U.S. Pat. No. 5,227,234 describes a vibration damping sheet which comprises a sheet substrate comprising an asphaltic material and a crystalline polyolefin particles on a surface of said sheet substrate.

### SUMMARY OF THE INVENTION

In one embodiment the invention comprises a composition comprising a
(i) polyamide,
(ii) 1-30 % by weight of the total formulation of a 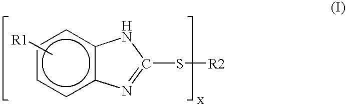
mercaptobenzoimidazole or mercaptobenzoimidazole metal salt represented by the following general formula (I) where is 1 or 2; R1 represents a hydrogen atom or an alkyl group of C1-C4; R2 represents a hydrogen atom when X is 1 and represents zinc or nickel when X is 2, and
(iii) optionally a plasticizer,
(iv) optionally an inorganic filler,
   In which the polyamide is selected form the group consisting of a crystalline polyamide, an amorphous polyamide and a mixture of a crystalline polyamide, an amorphous polyamide.

In a further embodiment the invention comprises compound (I) in an amount of 3-20% by weight of the total formulation.

In a further embodiment the invention comprises a metal-polymer-metal structural laminate comprising a core of polymeric material having adhered to each side thereof a metal skin layer wherein the metal skin layer is about 0.1 mm to about 10 mm thick, the laminate has a ratio of core thickness to skin thickness of between about 1:3 and about 20:1; the laminate total thickness is between about 0.3 mm and about 10 mm and polymeric material comprises
(i) polyamide,
(ii) 1-30 % by weight of the total formulation of a 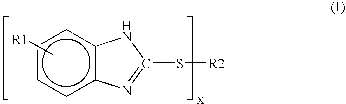
mercaptobenzoimidazole or mercaptobenzoimidazole metal salt represented by the following general formula (I) where is 1 or 2; R1 represents a hydrogen atom or an alkyl group of C1-C4; R2 represents a hydrogen atom when X is 1 and represents zinc or nickel when X is 2, and
(iii) optionally a plasticizer,
(iv) optionally an inorganic filler,
   in which the polyamide is selected form the group consisting of a crystalline polyamide, an amorphous polyamide and a mixture of a crystalline polyamide, an amorphous polyamide.

The structural laminate of the invention may comprise the metal skin layers on each side of the core being of different thicknesses or different metals.

In a further embodiment of the invention the ratio of core thickness to skin thickness is between 1:2 and 3:1.

In a still further embodiment of the invention the total laminate thickness is between 0.6 mm and 1.5 mm.

The laminate of the invention may also comprise a core that comprises a solid filler.

The laminate of the invention may also comprise a metal skin that is steel or aluminum.

A further embodiment of the invention is a method for manufacturing a sound dampening molding product comprising a step (a) of mixing polyamide and a mercaptobenzoimidazole or mercaptobenzoimidazole metal salt represented by the following general formula (I) 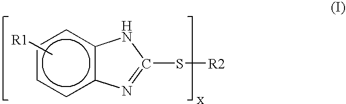
where is 1 or 2; R1 represents a hydrogen atom or an alkyl group of C1-C4; R2 represents a hydrogen atom when X is 1 and represents zinc or nickel when X is 2, and (b) a step of molding the molding product using the composition obtained in step (a).

### DETAILED DESCRIPTION OF THE INVENTION

The polyamide resin composition of the present invention can realize high dynamic viscoelasticity (tanδ) in a wide temperature range and can provide molding products with excellent dampening property. It is known that the maximum dampening performance will be displayed around the tanδ peak temperature (Japanese Kokai Patent Application No. Hei 2[1990]-120360 (patent reference 1), etc.). The composition of the present invention can increase tanδ used as the scale for dampening property. In particular, the composition of the present invention has a relatively low tanδ peak temperature (about 30-100° C.) and can increase tans higher that in the conventional technology. The composition of the present invention can provide molding products with high dampening property in average and even in a relatively low temperature range (for example, 50-80° C.). Also, the composition of the present can maintain or improve rigidity and other mechanical characteristics.

The present invention can comprise crystalline polyamide, amorphous polyamide or a blend of both. The weight-based mixture ratio of the crystalline polyamide (a) and amorphous polyamide (b) is in a range of a:b=100:0-0:100. In other words, in the present invention, the polyamide component may be a single crystalline polyamide or a single amorphous polyamide or a blend of both. In a preferred embodiment of the present invention, the polyamide component includes (a)18-92 wt % crystalline polyamide and (b) 1.5-40 wt % amorphous polyamide. The polyamide may be aliphatic or aromatic.

In the following, each component in the composition of the present invention will be explained.

### Aliphatic polyamide

There is no special limitation on the aliphatic polyamide, which can be polyamide 46, polyamide 66, polyamide 610, polyamide 612, polyamide 6, polyamide 11, polyamide 1010, polyamide 1012, polyamide 12, copolymer of PA66 and polyamide 6, copolymer of PA66 and polyamide 610, copolymer of PA66 and polyamide 612, etc. These polyamides can be used either alone or as a mixture of several types. It is preferred to use PA6 in the present invention.

### Aromatic Polyamide

The aromatic polyamide used in the present invention may be one or more homopolymers, copolymers, terpolymers, or higher polymers that are derived from monomers containing aromatic groups. It may also be a blend of one or more homopolymers, copolymers, terpolymers, or higher polymers that are derived from monomers containing aromatic groups with one or more aliphatic polyamides.

Examples of monomers containing aromatic groups are terephthalic acid and its derivatives, isophthalic acid and its derivatives, and m-xylylenediamine. It is preferred that about 5 to about 75 mole percent of the monomers used to make the aromatic polyamide used in the present invention contain aromatic groups, and more preferred that about 10 to about 55 mole percent of the monomers contain aromatic groups. Thus, preferably, about 5 to about 75 mole percent, or more preferably, 10 to about 55 mole percent of the repeat units of all polyamides used in the present invention contain aromatic groups.

The aromatic polyamide may be derived from one or more of adipic acid, sebacic acid, azelaic acid, dodecandoic acid, terephthalic acid, isophthalic acid or their derivatives and other aliphatic and aromatic dicarboxylic acids and aliphatic C₆-C₂₀ alkylenediamines, aromatic diamines, and/or alicyclic diamines. Preferred diamines include hexamethylenediamine; 2-methylpentamethylenediamine; 1,9-diaminononane; 1,10-diaminodecane; 1,12-diaminododecane; and m-xylylenediamine. It may also be derived from lactams or aminoacids.

Preferred aromatic polyamides include poly(m-xylylene adipamide) (polyamide MXD,6); poly(docemethylene terephthalamide) (polyamide 12,T); poly(decaamethylene terephthalamide) (polyamide 10,T); poly(nonamethylene terephthalamide) (polyamide 9,T); the polyamide of hexamethylene terephthalamide and hexamethylene adipamide (polyamide 6,T/6,6); the polyamide of hexamethyleneterephthalamide and 2-methylpentamethyleneterephthalamide (polyamide 6,T/D,T); the polyamide of hexamethylene terephthalamide and hexamethylene isophthalamide (polyamide 6,T/6,I) and copolymers and mixtures of these polymers.

### Amorphous Polyamide

For the amorphous polyamide the crystal melting heat quantity measured by a differential scanning calorimeter (DSC) is less than 1 cal/g. An example of amorphous polyamide has repeated units comprised of a part derived from an aromatic carboxylic acid and a part derived from aliphatic diamine.

Although there is no special limitation on the aforementioned aromatic carboxylic acid, terephthalic acid and its derivatives and isophthalic acid and its derivatives are preferred. In addition to the aforementioned aromatic carboxylic acid, it is also possible to use succinic acid, adipic acid, suberic acid, sebacic acid, dodecanoic diacid, or other aliphatic carboxylic acids as long as the purpose is not adversely affected.

Examples of the aforementioned aliphatic diamine include hexamethylene diamine, tetramethylene diamine, 2,5-dimethylhexamethylene diamine, etc.

In the present invention, as described above, an aromatic polyamide derived from aliphatic diamine terephthalic acid and its derivatives or isophthalic acid and its derivatives or other monomers can be used. An example is 6T/6I. In this case, “T” represents a polymer derived from terephthalic acid and its derivative, while “I” represents a polymer derived from isophthalic acid and its derivatives.

The aforementioned amorphous polyamide, for example, can be manufactured as follows. That is, the amorphous polyamide can be manufactured by a polycondensation reaction from the salt of the aforementioned aromatic carboxylic acid and aliphatic diamine. Polymerization is carried out using the conventional melt polymerization method, solid-state polymerization method, solution polymerization method, interfacial polymerization method, etc.

Although the aforementioned amorphous polyamide can be manufactured as descried above, it is also possible to use commercially available products, such as Amodel A-1000 (product of Amoco polymer Corporation) and Zytel® HTN (product of EI DuPont de Nemours & Co., Wilmington, Del.).

### Mercaptobenzoimidazole

The composition of the present invention comprises the mercaptobenzoimidazole represented by the above-mentioned general formula (I).

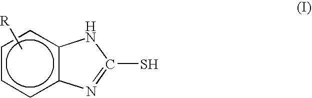

In formula (I), R represents a hydrogen atom or C1-C4 alkyl group.

The content of component (2) represented by general formula (I) is 1-30 wt %, preferably 3-20 wt %, based on the total weight of the composition.

### Plasticizer

It is preferable for the polyamide resin composition of the present invention to further include a plasticizer. Also, the polyamide resin composition of the present invention can further include an inorganic filler.

There is no special limitation on the plasticizer used in the present invention as long as it is compatible with aliphatic polyamide component (1) and/or amorphous polyamide component (2) on the molecular level and will not lower the tanδ peak temperature of the mixture of (1) and (2). Examples include water, alcohol, caprolactam, oligoamide, sulfone amide type compound, benzoate type compound, metal halide, etc. The plasticizer can be contained in the aforementioned polyamide (such as aliphatic polyamide) in advance or can be added into the composition of the present invention in other ways.

In the present invention, the content of the plasticizer is in the range of 0.5-20 wt %.

### Inorganic Filler

The polyamide resin composition of the present invention may also contain filler. Examples of filler include glass fiber, carbon fiber, mica, talc, kaolin, wollastonite, calcium carbonate, potassium titanate, etc. These fillers can be used either alone or as a mixture of several types. Glass fiber is preferred since it can improve the rigidity of the resin composition. Also, mica or talc is preferred since they can improve the dampening property.

In the present invention, the content of the inorganic filler is in the range of 0-60 wt %.

If necessary, other additives besides the aforementioned inorganic filler can also be added into the polyamide resin composition of the present invention. Examples of the aforementioned additives include thermal stabilizers, UV absorbents, antioxidants, lubricants, nuclear agents, antistatic agents, demolding agents, dye type coloring agents, pigment type coloring agents, flame retardants, plasticizers, and other resins.

The content of these additives are variable depending on the purpose of the additives. For example, it is preferred to be in the range of 0-10 wt % based on the total weight of the composition.

The composition of the present invention is the form of a mixture homogeneously dispersed in a polymer matrix such that all of the nonpolymerized components are integrated in the entire mixture. The mixture can be obtained by mixing the various components using any melt mixing method. Examples of the melt mixing method include the method in which the various components are homogeneously mixed using a monoaxial or biaxial screw extruder, blender, kneader, Banbury mixer, or other melt mixer (method that melts and mixes the various components of the composition of the present invention at the same time), or the method, in which some of the aforementioned materials are added sequentially or in a special combination by a melt mixer, followed by adding the rest of the materials and performing melt mixing until a homogenous mixture is obtained (the method using multiple stages). In the present invention, it is preferred to perform mixing in a special procedure as in the molding product manufacturing method to be described later. The mixing operation can be carried out continuously or using the batch method. Also, when the composition is prepared in multiple stages, it is also possible to temporarily cool off and solidify the mixed components between the stages.

The present invention is also directed to a method for manufacturing a molding product using the aforementioned polyamide resin composition. The method for manufacturing a sound dampening molding product comprises a step (a) of mixing polyamide and a mercaptobenzoimidazole or mercaptobenzoimidazole metal salt represented by the following general formula (I) 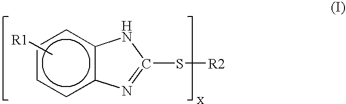
where is 1 or 2; R1 represents a hydrogen atom or an alkyl group of C1-C4; R2 represents a hydrogen atom when X is 1 and represents zinc or nickel when X is 2, and (b) a step of molding the molding product using the composition obtained in step (a).

In the manufacturing method of the present invention, first, the composition of the present invention is mixed by following any of the procedures explained above for the composition manufacturing method. Then, the obtained composition is molded using an injection molding method, blow molding method, sheet molding method, vacuum molding method, or other molding method. The molding conditions can be selected appropriately corresponding to each means. The conventional conditions can be used.

### EXAMPLES

Next, the present invention is explained in further detail by application examples and comparative examples, but the invention is to be understood to be not limited to these application examples.

In the following examples each component was mixed using compositions shown in the following Table 1 by a biaxial kneader, extruded, and pelletized. The amount of each component of Table 1 is given in wt %.

[The pellets obtained as mentioned above were injection-molded into specimens by an injection molding machine. The specimens obtained were tested according to the following methods.

For measurement of tan δ, the specimens (injection-molded bar: 55×10×4 mm) obtained by the above-mentioned method were measured at a temperature of 0-150° C. and a frequency of 2 Hz by using the 983 Dynamic Mechanical Analyzer made by the DuPont Instruments Co.

For measurement of tensile strength and elongation the specimens obtained by the above-mentioned method were measured according to ISO 527-1/−2.

For measurement of flexural strength and modulus the specimens obtained by the above-mentioned method were measured according to ISO 178.

For measurement of notched Charpy, the specimens obtained by the above-mentioned method were measured according to ISO 179/1 eA.

Table 1 shows the compositions of the examples. As the components of the composition of the application examples and the comparative examples, the following materials were used..Crystalline polyamide: Zytel (registered trademark) FE7330J made by Du Pont Zytel (registered trademark) 21A NC010 (containing 7% caprolactam (plasticizer) made by Du Pont. Amorphous polyamide (aromatic amorphous polyamide): Zytel (registered trademark) HTN503 made by Du Pont

Compounds of the general formula (I): Noklac MMB (R=Me) (made by Ouchi Shinko Kagaku K.K.) Noklac MB (R═H) (made by Ouchi Shinko Kagaku K.K.)

Plasticizer: Caprolactam (7% crystalline polyamide (Zytel 21A NCO10 made by Du Pont) is included.)

Inorganic filler: Glass fibers (CS FT756D; made by Asahi Glass Co., Ltd.)

TABLE I

| | Comparative | Application | Application | Application | Application |
|---|---|---|---|---|---|
| Composition | Example 1 | Example 1 | Example 2 | Example 3 | Example 4 |
| Aliphatic polyamide | 70.0 | 63.0 | — | — | — |
| (Zytel FE7330J) | | | | | |
| Plasticizer-containing | — | — | 63.0 | 50.4 | 63.0 |
| aliphatic polyamide | | | | | |
| (Zytel 21A NCO10^{a})) | | | | | |
| Amorphous polyamide | — | — | — | 12.6 | — |
| (Zytel HTN503) | | | | | |
| Compound of the | — | 7.00 | 7.00 | 7.00 | — |
| formula (I) (R = Me) | | | | | |
| Nokla c MMB | | | | | |
| Compound of the | — | — | — | — | 7.00 |
| formula (I) (R = H) | | | | | |
| Nokla c MB | | | | | |
| Inorganic filler | 30.0 | 30.0 | 30.0 | 30.0 | 30.0 |
| (CS FT756D) | | | | | |

^{a})Polyamide 6 includes a caprolactam at a content of 7%.

The results of characterization of the compositions of table 1 are shown in Table II.

TABLE II

| | | Comparative | Application | Application | Application | Application |
|---|---|---|---|---|---|---|
| | | Example 1 | Example □ | Example 2 | Example 3 | Example 4 |
| Tensile Strength | MPa | 183 | 205 | 191 | 196 | 184 |
| Elongation | % | 4.2 | 3.0 | 3.7 | 3.4 | 3.8 |
| Flex Strength | MPa | 281 | 298 | 297 | 288 | 285 |
| Flex Modulus | MPa | 8670 | 9590 | 9480 | 9110 | 9180 |
| N-Charpy | kJ/m2 | 11.7 | 10.8 | 12.1 | 10.5 | 12.1 |

Also, the values of the measured dynamic viscoelasticity (tan δ) were plotted with respect to the temperature, and the results are shown in FIG. 1.

As seen from the results, it is understood that the polyamide resin composition of the present invention has a high tan δ value and an excellent vibration damping property, compared with the comparative example. In particular, the polyamide resin composition of the present invention is a composition in which the highest value of tan δ is well maintained in a range of about 50-100° C., with the tan δ value being high in a wide temperature range in accordance with the composition.

Also, as seen from Table II, the polyamide resin composition of the present invention has about the same mechanical properties as those of Comparative Example 1 or has mechanical properties superior to those of Comparative Example 1.

1.) A composition comprising a
(i) polyamide,
(ii) 1-30% by weight of the total formulation of a 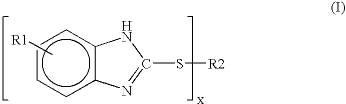
mercaptobenzoimidazole or mercaptobenzoimidazole metal salt represented by the general formula (I) where is 1 or 2; R1 represents a hydrogen atom or an alkyl group of C1-C4; R2 represents a hydrogen atom when X is 1 and represents zinc or nickel when X is 2, and
(iii) optionally a plasticizer,
(iv) optionally an inorganic filler at a level of from 0-60% by weight of the total formulation.,
In which the polyamide is selected form the group consisting of a crystalline polyamide, an amorphous polyamide and a mixture of a crystalline polyamide, an amorphous polyamide.

2.) The composition of claim 1 in which compound (I) is present in an amount of 3-20% by weight of the total.

3.) A metal-polymer-metal structural laminate comprising a core of polymeric material having adhered to each side thereof a metal skin layer wherein:
(a) said metal skin layer is about 0.1 mm to about 10 mm thick;
(b) said laminate has a ratio of core thickness to skin thickness of between about 1:3 and about 20:1;
(c) said laminate total thickness is between about 0.3 mm and about 10 mm;
(d) said polymeric material comprises
(i) polyamide,
(ii) 1-30% by weight of the total formulation of a 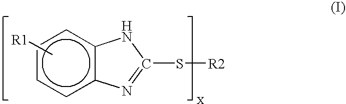
mercaptobenzoimidazole or mercaptobenzoimidazole metal salt represented by the following general formula (I) where is 1 or 2; R1 represents a hydrogen atom or an alkyl group of C1-C4; R2 represents a hydrogen atom when X is 1 and represents zinc or nickel when X is 2, and
(iii) optionally a plasticizer,
(iv) optionally an inorganic filler,
In which the polyamide is selected form the group consisting of a crystalline polyamide, an amorphous polyamide and a mixture of a crystalline polyamide, an amorphous polyamide.

4.) The structural laminate of claim 3 wherein the metal skin layers on each side of the core are different thicknesses.

5.) The structural laminate of claim 3 wherein the metal skin layers on each side of the core comprise different metals.

6.) The laminate of claim 3 wherein the ratio of core thickness to skin thickness is between 1:2 and 3:1.

7.) The laminate of claim 3 wherein the total laminate thickness is between 0.6 mm and 1.5 mm.

8.) The laminate of claim 3 wherein the core comprises a solid filler.

9.) The structural laminate of claim 3 wherein the metal skin is steel.

10.) The structural laminate of claim 3 wherein the metal skin is aluminum.

11.) A method for manufacturing a sound dampening molding product comprising a step (a) of mixing polyamide and a mercaptobenzoimidazole or mercaptobenzoimidazole metal salt represented by the following general formula (I) 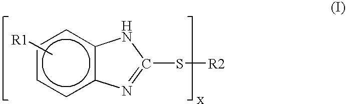
where is 1 or 2; R1 represents a hydrogen atom or an alkyl group of C1-C4; R2 represents a hydrogen atom when X is 1 and represents zinc or nickel when X is 2, and (b) a step of molding the molding product using the composition obtained in step (a).
